(19) United States
(12) Patent Application Publication
(10) Pub. No.: US 2026/0362306 A1
(43) Pub. Date: Nov. 12, 2026

(54) BASE STATION-INITIATED SUPPORT FOR GRANULAR CONTROL OVER NETWORK SLICE-AREA-OF-SERVICE

(71) Applicant: Verizon Patent and Licensing Inc., Basking Ridge, NJ (US)

(72) Inventors: Ambreen Habib, Golden, CO (US); Sudhakar Reddy Patil, Flower Mound, TX (US); Violeta Cakulev, Millburn, NJ (US); Ali Imdad Malik, East Brunswick, NJ (US)

(21) Appl. No.: 19/202,598

(22) Filed: May 8, 2025

(51) Int. Cl. H04W 48/18; H04W 48/08; H04W 60/04

(52) U.S. Cl. CPC H04W 48/18; H04W 48/08; H04W 60/04

(57) ABSTRACT

A system may include a device configured to receive, from a management device, Network Slice-Area-of-Service (NS-AoS) data per cell and additional data. The device may also be configured to send the NS-AoS data and the additional data to a network function.

### BACKGROUND INFORMATION

Fifth Generation (5G) networks introduce several advancements that enhance flexibility, efficiency, and scalability compared to previous generations of networks. A key innovation is the adoption of a Service-Based Architecture (SBA), which enables network functions to communicate through standardized Application Programming Interfaces (APIs). This architecture simplifies network management, improves interoperability, and accelerates the deployment of new services. Additionally, SBA facilitates seamless integration with Multi-Access Edge Computing (MEC) clusters, optimizing traffic steering and reducing latency. At the core of SBA is the Access and Mobility Management Function (AMF), which controls user devices’ access to the provider network. By leveraging the SBA and AMFs, 5G networks achieve greater resource efficiency, faster service rollout, enhanced security, and improved network performance.

### BRIEF DESCRIPTION OF THE DRAWINGS

FIG. 1 illustrates concepts described herein.

FIG. 2 illustrates an exemplary network environment in which systems and methods described herein may be implemented.

FIG. 3 illustrates exemplary 5G core network components, according to an implementation.

FIG. 4 illustrates simplified example operation of a User Equipment device (UE) and a cellular network to support granular control over Network Slice Area-of-Service (NS-AoS).

FIG. 5 is a flow diagram of an exemplary process for supporting granular control over NS-AoS, according to an implementation.

FIG. 6 is a messaging diagram among example network components and functions for supporting granular control over NS-AoS, according to an implementation.

FIG. 7 depicts exemplary functional components of a network device according to an implementation.

### DETAILED DESCRIPTION

The following detailed description refers to the accompanying drawings. The same reference numbers in different drawings may identify the same or similar elements. As used herein, the terms “service provider” and “provider network” may refer to, respectively, a provider of communication services and a network operated by the service provider. The network may include a cellular network. A cellular network may be uniquely identified by a Public Land Mobile Network (PLMN) Identifier (ID).

As used herein, the term “cell” may refer the basic unit of radio coverage in a cellular (or mobile) network. A cell may be created by a base station (e.g., Next Generation Node B (gNB) in a Fifth Generation (5G) network) and may define the geographical area where a User Equipment device (UE) (e.g., a smart phone) may connect to the network via radio signals. A cell may have a unique cell identifier (ID), operate in specific frequencies, and provide a coverage over a defined area. Each cell may broadcast System Information Blocks (SIBs) to UEs within the cell.

As used herein, the term “tracking area” or TA may refer to a group of cells. Tracking areas may be used by network components or network functions, such as an Access and Mobility Management function (AMF), to keep track of UE locations. Each tracking area may have a tracking area identity or identifier (TAI), which includes a Tracking area code (TAC) and a PLMN ID. A cell can belong to more than one tracking area. When a UE moves from one TA to another TA, the UE is required to send a tracking area update (TAU) message to the AMF managing the UE. In contrast, a UE that moves from one cell to another (or is transferred from one cell to another) may not send an update message that notifies the AMF of the change in cell ID.

The systems and methods described herein pertain to base station-initiated support for granular control over a Network Slice–Area of Service (NS-AoS). An Area of Service (AoS) refers to the geographic region where a UE can access a provider network and obtain service for a specific network slice that has resources allocated to the slice. A network slice is considered supported and available within a TA only if the slice is available with more than zero resources in all cells within the TA.

In typical implementations, NS-AoS is defined at the Tracking Area level. Consequently, network slices are commonly deployed such that AoS boundaries align with TA boundaries. However, certain use cases may benefit from more flexible deployment strategies, where AoS boundaries differ from those of TAs. Consider, for example, a scenario where a cell within a TA is assigned a network slice that lacks any allocated resources. In such cases, the network slice may be marked as supported but unavailable. When a UE resides in that cell, the network must redirect the UE to another cell where a corresponding network slice is provisioned with non-zero resources. This redirection process becomes significantly more efficient when the network has access to cell-level granularity AoS information rather than relying solely on TA-level granularity.

Responsibility for managing such inter-cell UE transfers typically resides with the AMF. The AMF obtains NS-AoS information from the core Operations, Administration, and Management/Maintenance system (core OAM), which operates within the core network. However, the core OAM generally lacks awareness of NS-AoS data at the cell level, as no synchronization occurs with Radio Access Network OAM systems (RAN-OAMs), which may maintain AoS data at cell-level granularity.

The described systems and methods address the above issue by enabling RAN elements to transmit cell-level NS-AoS information to the AMF via the N2 interface. This approach enhances mobility management by enabling more precise and responsive network slice availability awareness. Upon receipt of the cell-level NS-AoS data, the AMF may apply NS-AoS control at the cell-level granularity.

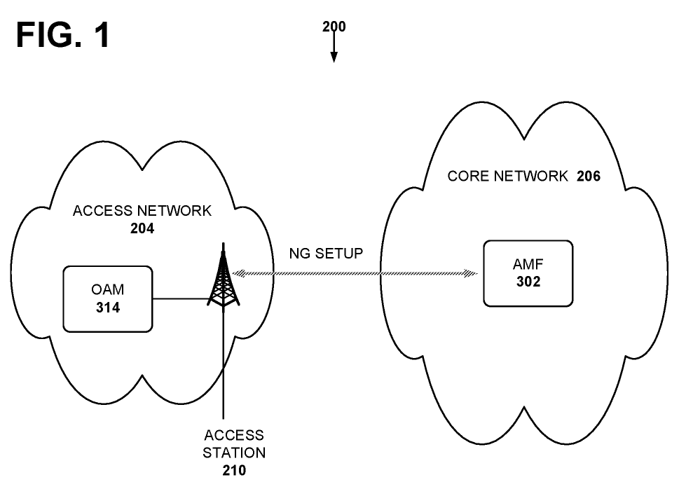

FIG. 1 illustrates the concepts described herein. As shown, a portion of network environment 200 includes an access network 204 and a core network 206. Access network 204 (e.g., a Radio Access Network, (RAN)) may include an access station 210 (e.g., a gNB) and a RAN-OAM 314. Core network 206 may include an AMF 302. Although RAN-OAM 314 is depicted as part of access network 204, in other implementations, RAN-OAM 314 may reside outside access network 204.

To enable base station–initiated support for supporting granular control over NS-AoS, access station 210 is provisioned with logic that, upon receiving cell-level AoS data from a network administrator or another component of network environment 200, transmits an NG SETUP REQUEST message (as defined by the N2 interface) to AMF 302 in core network 206. The NG SETUP REQUEST may include information indicating network slice availability at the cell level. In response, AMF 302 may store the received cell-level slice availability data for future use.

When a UE (not shown in FIG. 1) establishes a radio connection with access station 210 and initiates registration with AMF 302, AMF 302 may reference the previously received cell-level NS-AoS information and retrieve the user profile from another network function (e.g., Unified Data Management (UDM), not shown). Based on the combination of cell-level NS-AoS data and the subscribed slice information in the user profile, AMF 302 may derive a list of allowed network slices, also known as the Network Slice Selection Assistance Group (NSSAG). Upon successful completion of the UE registration procedure, AMF 302 may include the NSSAG information in the Registration Accept message sent to the UE. That is, AMF 302 may restrict the NSSAG to the network slices identified in both the network profile and NS-AoS data. This, in turn, permits the UE to be efficiently transferred to cells with network slices that have non-zero allocated resources.

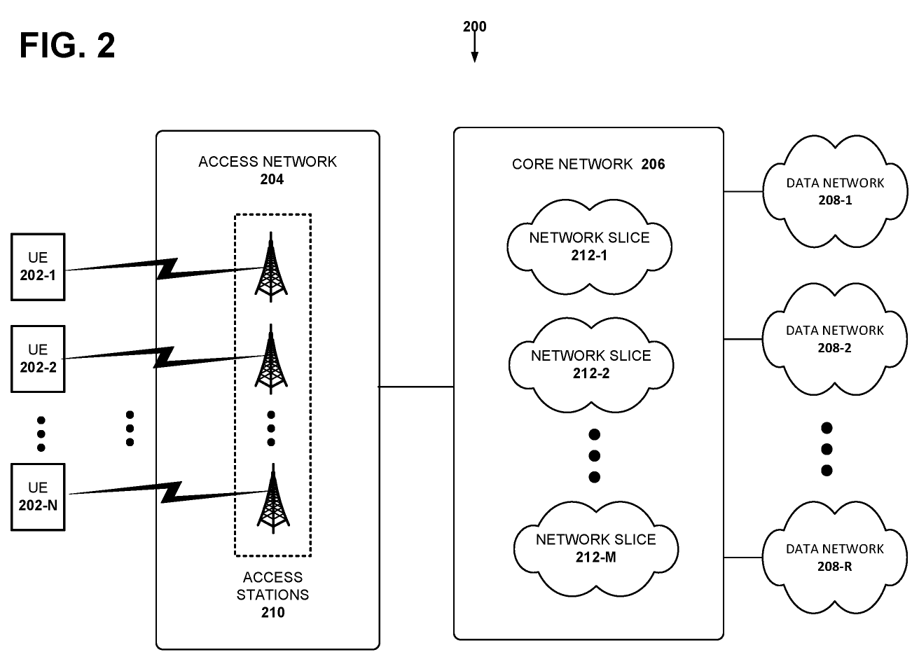

FIG. 2 illustrates an exemplary network environment 200 in which the systems and methods may be implemented. As shown, environment 200 may include UEs 202-1 through 202-N (collectively referred to as UEs 202 and generically referred to as UE 202), access network 204, core network 206, and data networks 208-1 through 208-R (collectively referred to as data networks 208 and generically referred to as data network 208). Access network 204, core network 206, and data networks 208 may be part of a provider network (not shown in FIG. 2).

UEs 202 may include wireless communication devices capable of 5G New Radio (NR) communication. Some UEs 202 may additionally include Fourth Generation (4G) (e.g., Long-Term Evolution (LTE)) communication capabilities or Sixth Generation (6G) communication capabilities. Examples of UE 202 include: a smart phone; a tablet device; a wearable computer device (e.g., a smart watch); a global positioning system (GPS) device; a laptop computer; a media playing device; a portable gaming system; an autonomous vehicle navigation system; a sensor, such as a pressure sensor; a Fixed Wireless Access (FWA) device; a Customer Premises Equipment (CPE) device, with or without Wi-Fi® capabilities; and an Internet-of-Things (IoT) device. In some implementations, UE 202 may correspond to a wireless Machine-Type-Communication (MTC) device that communicates with other devices over a machine-to-machine (M2M) interface, such as LTE-M or Category M1 (CAT-M1) devices and Narrow Band (NB)-IoT devices.

UEs 202 may be associated with a user that is subscribed to the provider network to receive various services. UE 202 may operate in accordance with subscription data stored at the provider network. To receive network services, UEs 202 attach to the provider network wirelessly and establish communication sessions with the network. In requesting a connection, UE 202 may provide an ID of the network slice from which UE 202 wants the network services.

UE 202 may include IDs for different types of network slices. A network slice ID may include a Single-Network Slice Selection Assistance Information (S-NSSAI). The S-NSSAIs may include configured NSSAIs (C-NSSAIs) (also referred to as subscribed NSSAIs), allowed NSSAIs (A-NSSAIs or NSSAG), and requested NSSAIs (R-NSSAIs). A C-NSSAI may identify a network slice to which the UE 202 is subscribed. An A-NSSAI may include a S-NSSAIs that identifies a network slice (e.g., a network slice 212 described below) with which UE 202 may establish a protocol data unit (PDU) session. A-NSSAIs may include a subset of S-NSSAIs included in the C-NSSAIs and the available S-NSSAIs (identified by NS-AoS data sent by access station to AMF 302 via an NG SETUP REQUEST message). R-NSSAIs may include a set of S-NSSAIs that UE 202 requests from the provider network for approval during its registration. The A-NSSAIs may or may not include the R-NSSAIs sent by UE 202. After the registration, UE 202 may attempt to establish a session with one of the A-NSSAIs.

Access network 204 may allow UE 202 to access core network 206. To do so, access network 204 may establish and maintain, with participation from UE 202, an over-the-air channel with UE 202; and maintain backhaul channels with core network 206. Access network 204 may relay information through such channels, from UEs 202 to core network 206 and vice versa. Access network 204 may include an LTE radio network and/or a 5G NR network, or another advanced radio network. These networks may include many central units (CUs), distributed units (DUs), radio units (RUs), and wireless stations, some of which are illustrated in FIG. 2 as access stations 210 (herein generically referred to as access station 210) for establishing and maintaining over-the-air channel with UEs 202. In some implementations, access station 210 may include a 4G, 5G, 6G or another type of base station (e.g., eNB, gNB, etc.) that includes one or more radio frequency (RF) transceivers. In some implementations, access station 210 may be part of an evolved Universal Mobile Telecommunications Service (UMTS) Terrestrial Radio Access Network (eUTRAN).

As indicated above, access stations 210 may include logic to send NS-AoS data received from RAN-OAM 314 (see FIGS. 1, 3, and 6). Access station 210 may send NS-AoS data when access station 210 boots up add/or upon receipt of updates from the RAN-OAM 314. Each time access station 210 updates its network slice configuration at the cell-level, access station 210 may send a new NG SETUP REQUEST to AMF 302. When UE 202 changes cells via handoffs, access station 210 may enforce NS-AoS at the cell level, as access station 210 is NS-AoS aware at the cell level (due to OAM-RAN 314).

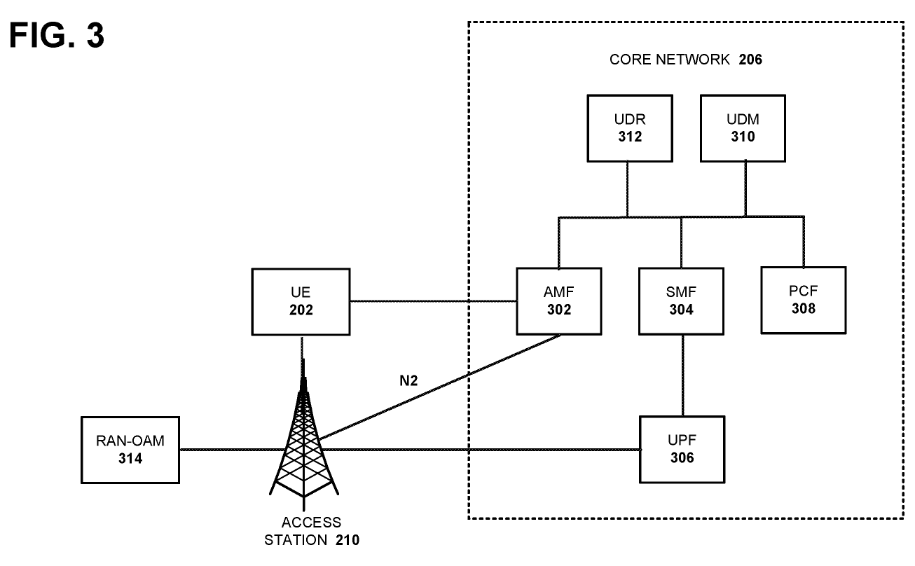

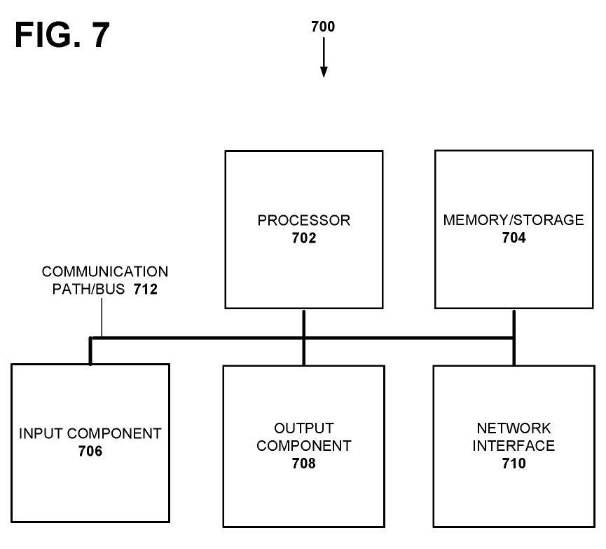

Core network 206 may manage communication sessions of UEs 202 connecting to core network 206 via access network 204. For example, core network 206 may establish an Internet Protocol (IP) connection between UEs 202 and data networks 208. The components of core network 206 may be implemented as dedicated hardware components or as virtualized functions implemented on top of a common shared physical infrastructure using Software Defined Networking (SDN). For example, an SDN controller may implement one or more of the components of core network 206 using an adapter implementing a virtual network function (VNF) virtual machine, a Cloud Native Function (CNF) container, an event driven server-less architecture interface, and/or another type of SDN component. The common shared physical infrastructure may be implemented using one or more devices 700 described below with reference to FIG. 7 in a cloud computing center associated with core network 206. Core network 206 may include 5G core network components, 4G core network components, and/or another type of core network components (e.g., 6G core network components). Some of 5G core network components that may include part of the system for supporting granular control over NS-AoS are described below with reference to FIG. 3.

As further shown, core network 206 may include one or more network slices 212-1 through 212-M (herein collectively referred to as network slices 212 and generically as network slice 212). Depending on the implementation, network slices 212 may be implemented within other networks, such as access network 204 and/or data network 208. Access network 204, core network 206, and data networks 208 may include multiple instances of network slices 212. Each network slice 212 may be instantiated as a result of “network slicing,” which involves a form of virtual network architecture that enables multiple logical networks to be implemented on top of a shared physical network infrastructure using SDN and/or network function virtualization (NFV). Each logical network, referred to as a “network slice,” may encompass an end-to-end virtual network with dedicated storage and/or computational resources that include access network components, clouds, transport, Central Processing Unit (CPU) cycles, memory, etc. Furthermore, each network slice 212 may be configured to meet a different set of requirements and may be associated with a particular Quality-of-Service (QoS) class, a type of service, 5G QoS Identifier (5QI), and/or a particular group of enterprise customers associated with communication devices. Network slices 212 may be capable of supporting enhanced Mobile Broadband (eMBB) traffic, Ultra Reliable Low Latency Communication (URLLC) traffic, Time Sensitive Network (TSN) traffic, Massive IoT (MIoT) traffic, Vehicle-to-Everything (V2X) traffic, High performance Machine Type Communication (HMTC) traffic, and other customized traffic, for example.

Each network slice 212 may be associated with an identifier, S-NSSAI, and/or a network slice instance ID. Each UE 202 that is configured to access a particular network slice 212 may be associated with corresponding subscription data, stored in core network 206 for example, which includes the S-NSSAI corresponding to the network slice. As indicated above, S-NSSAIs of network slices to which UE 102 is subscribed are referred to as C-NSSAIs. NSSAI may refer to a set of S-NSSAIs or multiple S-NSSAIs.

Data networks 208 may include one or more networks connected to core network 206. In some implementations, a particular data network 208 may be associated with a data network name (DNN) in 5G and/or an Access Point Name (APN) in 4G. UE 202 may request a connection to data network 208 using a DNN or APN. Each data network 208 may include, and/or be connected to and enable communications with, a local area network (LAN), a wide area network (WAN), a metropolitan area network (MAN), an autonomous system (AS) on the Internet, an optical network, a cable television network, a satellite network, another wireless network (e.g., a Code Division Multiple Access (CDMA) network, a general packet radio service (GPRS) network, an LTE network), an ad hoc network, a telephone network (e.g., the Public Switched Telephone Network (PSTN) or a cellular network), an intranet, or a combination of networks. Data network 208 may include an application server (also referred to as application). An application may provide services for a program or an application running on UE 202 and may establish communication sessions with UE 202 via core network 206.

For clarity, FIG. 2 does not show all components that may be included in network environment 200 (e.g., routers, bridges, wireless access point, additional networks, data centers, portals, etc.). Depending on the implementation, network environment 200 may include additional, fewer, different, or a different arrangement of components than those illustrated in FIG. 2. Furthermore, in different implementations, the configuration of network environment 200 may be different.

FIG. 3 depicts exemplary 5G core network components 302-312 in core network 206. FIG. 3 also depicts RAN-OAM 314, UE 202, and access station 210. One or more core network components (e.g., components 302-312), in conjunction with other network components (e.g., UE 202, access station 210, and RAN-OAM 314), may implement the systems and methods for supporting granular control over NS-AoS. As shown, core network 206 may include NFs, such as an AMF 302, a Session Management Function (SMF) 304, a User Plane Function (UPF) 306, a Policy Control Function (PCF) 308, a Unified Data Management (UDM) 310, and a Unified Data Repository (UDR) 312.

Although FIG. 3 shows core network 206 as including 5G core network components 302-312, in practice, core network 206 may include additional, fewer, and/or different core network components than those illustrated in FIG. 3. For example, core network 206 may include 4G core network components (e.g., a Mobility Management Entity (MME), a Serving Gateway (SGW), a Packet Data Network Gateway (PGW), a Policy and Charging Rules Function (PCRF), a Home Subscriber Server (HSS), a Service Capability Exposure Function (SCEF), and an AS. In another example, core network 206 may include an Authentication Server Function (AUSF), a Charging Function (CHF), a Network Slice Selection Function (NSSF), a Network Exposure Function (NEF), a Network Repository Function (NRF), etc.

AMF 302 may perform registration management, connection management, reachability management, mobility management, lawful intercepts, Short Message Service (SMS) transport between UE 202 and a Short Message Service Function (SMSF), session management messages transport between UE 202 and SMF 304, access authentication and authorization, location services management, functionality to support non-3GPP access networks, and/or other types of management processes.

As indicated above, AMF 302 may receive NS-AoS data from RAN (e.g., access stations 210) over the N2 interface. NS-AoS information may include data at the cell level and/or the TA level. Upon receipt of NS-AoS data from access station 210, AMF 302 may store the NS-AoS data for later use. For example, when AMF 302 receives a registration request from UE 202, AMF 302 may identify allowed network slices 212 for UE 202 based on the NS-AoS data and C-NSSAIs obtained from the subscriber profile associated with the user of UE 202. For example, AMF 302 may determine an intersection of the following sets of S-NSSAIs: R-NSSAIs, C-NSSAIs, and S-NSSAIs identified by NS-AoS, which identifies available network slices for the cell. After obtaining the A-NSSAIs, AMF 302 may provide the A-NSSAIs to UE 202, via a registration accept message.

SMF 304 may perform session establishment, session modification, and/or session release, perform IP address allocation and management, perform Dynamic Host Configuration Protocol (DHCP) functions, perform selection and control of UPF 306, configure traffic steering at UPF 306 to guide the traffic to the correct destinations, terminate interfaces toward PCF 308, perform lawful intercepts, charge data collection, support charging interfaces, control and coordinate charging data collection, terminate session management parts of Non-Access Stratum (NAS) messaging, perform downlink data notification, manage roaming functionality, and/or perform other types of control plane processes for managing user plane data.

UPF 306 may maintain an anchor point for intra/inter-Radio Access Technology (RAT) mobility, maintain an external protocol data unit (PDU) point of interconnect to a particular data network (e.g., data network 208), perform packet routing and forwarding, perform the user plane part of policy rule enforcement, perform packet inspection, perform lawful intercept, perform traffic usage reporting, perform QoS handling on the user plane, perform uplink traffic verification, perform transport level packet marking, perform downlink packet buffering, forward an “end marker” to a RAN node (e.g., access station 210), and/or perform other types of user plane processes.

PCF 308 may support policies to control network behavior, provide policy rules to control plane functions (e.g., to AMF 302, SMF 304, etc.), access subscription information relevant to policy decisions, make policy decisions, and/or perform other types of processes associated with policy enforcement. When PCF 308 receives an SM Policy Association Create message from SMF 304, PCF 308 may provide a response that includes a session rules and one or more Policy and Control Charging (PCC) rules.

UDM 310 may maintain subscription information for UEs 202, manage subscriptions, generate authentication credentials, handle user identification, perform access authorization based on subscription data, perform network function registration management, maintain service and/or session continuity by maintaining assignment of SMF 304 for ongoing sessions, support SMS delivery, support lawful intercept functionality, and/or perform other processes associated with managing user data. UDM 310 may store data that it manages in UDR 312. UDR 312 may include subscription data, policy data, and application data. The subscription data may include data associated with the subscribers of network services (e.g., users of UE 202), The subscriber data may include, for example, C-NSSAIs. The policy data may include policy rules and parameters associated with the policy rules. The application data may comprise information and/or data collected by applications.

RAN-OAM 314 may include logic for operating, authorizing, and managing/maintaining various elements of access network 204. For example, RAN-OAM 314 may receive NS-AoS data from other devices and/or network operators and provide the data to access station 210.

Access station 210, as described above, may receive NS-AoS data from RAN-OAM 314. Upon receipt of the data or upon boot up, access station 210 may send an NG SETUP REQUEST (part of N2 interface) to provide various parameters to AMF 302, including NS-AoS data. Each NG SETUP REQUEST may identify the IDs of available network slices for a tracking area (which is identified by TAI) and the IDs of available network slices for the cell corresponding to access station 210. As indicated above, access station 210 may include a base station, a CU, or another type of RAN element.

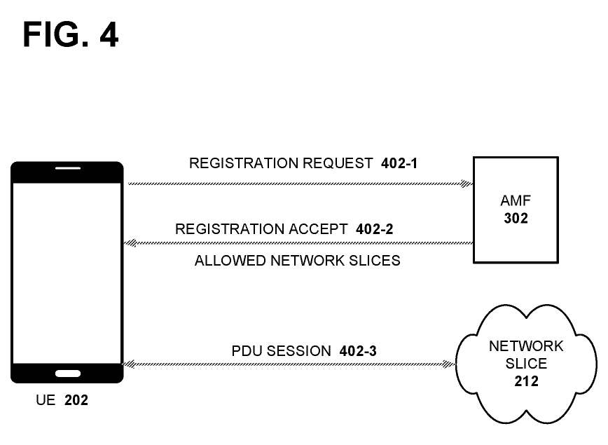

FIG. 4 illustrates simplified example operation of UE 202, AMF 302, and network slice 212 to support granular control over NS-AoS, according to an implementation. For FIG. 4, assume that access station 210 (not shown in FIG. 4) sent NS-AoS data pertaining to the corresponding cell to AMF 302 and that AMF 302 stored the NS-AoS data.

As shown, after AMF 302 stored the cell-level NS-AoS data, UE 202 may send a REGISTRATION REQUEST message 402-1 to AMF 302. In response, AMF 302 may perform a registration procedure for UE 202, including fetching a subscription profile pertaining to UE 202 from UDR 312 (e.g., via UDM 310). AMF 302 may then extract C-NSSAIs from the subscription profile and retrieve the cell-level NS-AoS data (e.g., a list of S-NSSAIs for the cell that includes UE 202). AMF 302 may then derive the intersection of the following sets of S-NSSAIs: C-NSSAIs, NS-AoS network slice IDs, and/or R-NSSAIs sent by UE 202 in its registration request. Upon completion of the registration, AMF 302 may send REGISTRATION ACCEPT reply 402-2, with the intersection set of S-NSSAIs as the allowed S-NSSAIs (A-NSSAIs). When UE 202 receives REGISTRATION ACCEPT message and the A-NSSAIs, UE 202 may request and establish a session 402-3 with a network slice 212 identified by one of the A-NSSAIs. By this process, AMF 302 may support or enforce the cell-level control over NS-AoS by restricting the set of A-NSSAIs to those network slice IDs included in the NS-AoS data for the cell.

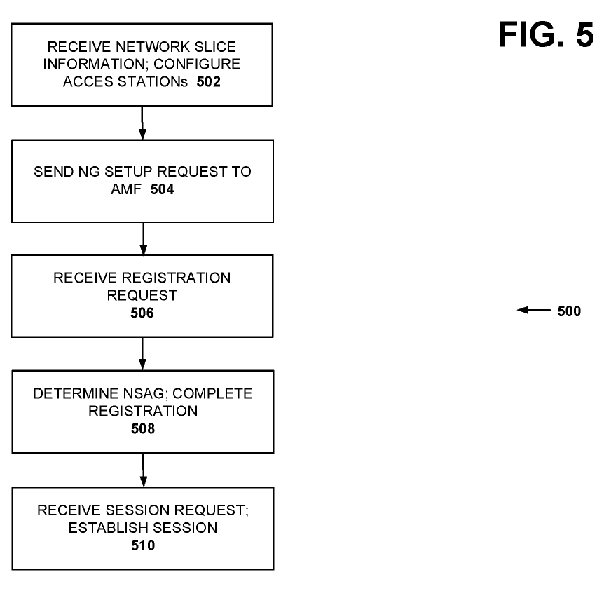

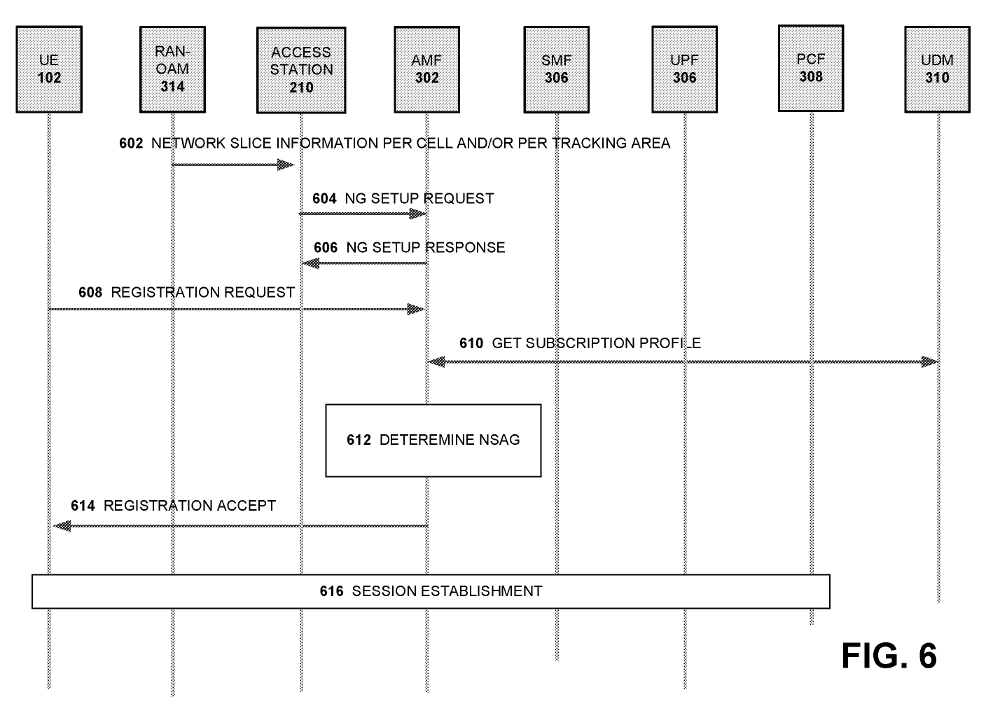

FIG. 5 is a flow diagram of an exemplary process 500 for supporting granular control over NS-AoS, according to an implementation. Process 500 may be performed by one or more UEs 202, access station 210 (or RAN), AMF 302, SMF 304, UPF 306, PCF 308, UDM 310, UDR 312, and/or RAN-OAM 314. FIG. 6 is a messaging diagram among example network components or functions of the provider network during process 500.

As shown, process 500 may include receiving network slice information per cell and/or per tracking area and configuring accessing stations 210 (block 502). For example, RAN-OAM 314 may receive NS-AoS data per cell and/or tracking area from devices or network operators (arrow 602, FIG. 6). As a result of receiving the information from RAN-OAM 314, access station 210 may be configured.

Process 500 may further include sending NS-AoS data per cell and/or per tracking area to AMF 302 (block 504). For example, after the configuration, access station 210 may send an NG SETUP REQUEST message (part of N2 interface) to AMF 302 (arrow 604). The NG SETUP REQUEST message may include the NS-AoS data at the cell level and/or TA level granularity. In response to the NG SETUP REQUEST, AMF 302 may store selected data from the request, including the NS-AoS data at the cell level and/or tracking area level granularity. Thereafter, AMF 302 may send a NG SETUP RESPONSE in response to the NG SETUP REQUEST to access station 210 (arrow 606).

Process 500 may further include receiving a registration request (block 506). For example, UE 202 may send a REGISTRATION REQUEST to AMF 302 via access station 210 (arrow 608). The registration request may include R-NSSAIs—a list of requested network slices to which UE 202 may connect. In response to the registration request, AMF 302 may start the corresponding registration process, which includes retrieving a subscriber profile for the user of UE 202 via UDM 310 (arrow 610). UDM 310 may then fetch the subscription profile from UDR 312 (not shown in FIG. 6) and provide the subscription profile to AMF 302. The subscription profile may include C-NSSAIs identifying the network slices to which the user of UE 202 is subscribed.

Process 500 may further include determining NSSAG and completing the registration (block 508). For example, AMF 302 may determine NSSAG (block 612) by computing the intersection of different sets of S-NSSAIs: C-NSSAIs obtained from the subscription profile, S-NSSAIs from the NS-AoS data for the cell (stored earlier), and/or R-NSSAIs included in the registration request. In addition, AMF 302 may complete the registration of UE 202 and send a REGISTRATION ACCEPT message to UE 202 (arrow 614). The registration accept message may include the A-NSSAIs.

Process may include receiving a session request and establishing the session (block 510; block 616). For example, UE 202 may send a session request (via access station 210) to AMF 302. In response, AMF 302 may initiate a cascade of messaging between various components of core network 206 to establish the session. The components may include, for example, SMF 304, UPF 306, PCF 308, UDM 310, UDR 312, and/or other components (e.g., AUSF).

In process 500, RAN-OAM 314, access station 210 (or the RAN), and/or AMF 302 may support cell-level control over NS-AoS. The system may support and/or enforce cell-level control over NS-AoS by obtaining NS-AoS data at the cell-level granularity and passing the NS-AoS data to AMF 302 via access station 210. Later, when UE 202 registers with AMF 302, AMF 302 may enforce NS-AoS by selecting S-NSSAIs from the network slices identified by NS-AoS of the cell and/or other S-NSSAIs (e.g., C-NSSAIs, R-NSSAIs, etc.), and sending the selected S-NSSAIs as the A-NSSAIs to UE 202. Accordingly, UE 202 may connect with a network slice 212 identified by NS-AoS data.

FIG. 7 depicts exemplary components of an exemplary network device 700. Network device 700 may correspond to or be included in any of the devices and/or components illustrated in FIGS. 1-4 and 6 (e.g., UE 202, access network 204, core network 206, data network 208, access station 210, AMF 302, SMF 304, UPF 306, PCF 308, UDM 310, UDR 312, RAN-OAM 314, etc.). In some implementations, network devices 700 may be part of a hardware network layer on top of which other network layers and network functions (NFs) may be implemented.

As shown, network device 700 may include a processor 702, memory/storage 704, input component 706, output component 708, network interface 710, and communication path 712. In different implementations, network device 700 may include additional, fewer, different, or different arrangement of components than the ones illustrated in FIG. 7. For example, network device 700 may include line cards, switch fabrics, modems, etc.

Processor 702 may include a processor, a microprocessor, an Application Specific Integrated Circuit (ASIC), a Field Programmable Gate Array (FPGA), programmable logic device, chipset, application specific instruction-set processor (ASIP), system-on-chip (SoC), central processing unit (CPU) (e.g., one or multiple cores), microcontrollers, and/or other processing logic (e.g., embedded devices) capable of controlling network device 700 and/or executing programs/instructions.

Memory/storage 704 may include static memory, such as read only memory (ROM), and/or dynamic memory, such as random access memory (RAM), or onboard cache, for storing data and machine-readable instructions (e.g., programs, scripts, etc.). Memory/storage bmay also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 704 may be external to and/or removable from network device 700. Memory/storage 704 may include, for example, a Universal Serial Bus (USB) memory stick, a dongle, a hard disk, off-line storage, a Blu-Ray® disk (BD), etc. Memory/storage 704 may also include devices that can function both as a RAM-like component or persistent storage, such as Intel ® Optane memories. Depending on the context, the term “memory,” “storage,” “storage device,” “storage unit,” and/or “medium” may be used interchangeably. For example, a “computer-readable storage device” or “computer-readable medium” may refer to both a memory and/or storage device.

Input component 706 and output component 708 may provide input and output from/to a user to/from network device 700. Input/output components 706 and 708 may include a display screen, a keyboard, a mouse, a speaker, a microphone, a camera, a DVD reader, USB lines, and/or other types of components for obtaining, from physical events or phenomena, to and/or from signals that pertain to network device 700.

Network interface 710 may include a transceiver (e.g., a transmitter and a receiver) for network device 700 to communicate with other devices and/or systems. For example, via network interface 710, network device 700 may communicate over a network, such as the Internet, an intranet, cellular, a terrestrial wireless network, a satellite-based network, optical network, etc. Network interface 710 may include a modem, an Ethernet interface to a LAN, and/or an interface/connection for connecting network device 700 to other devices.

Communication path or bus 712 may provide an interface through which components of network device 700 can communicate with one another.

Network device 700 may perform the operations described herein in response to processor 702 executing software instructions stored in a non-transient computer-readable medium, such as memory/storage 704. The software instructions may be read into memory/storage 704 from another computer-readable medium or from another device via network interface 710. The software instructions stored in memory/storage 704, when executed by processor 702, may cause processor 702 to perform one or more of the processes that are described herein.

In this specification, various preferred embodiments have been described with reference to the accompanying drawings. It will be evident that modifications and changes may be made thereto, and additional embodiments may be implemented, without departing from the broader scope of the invention as set forth in the claims that follow. The specification and drawings are accordingly to be regarded in an illustrative rather than restrictive sense.

In the above, while series of actions, messages, and/or signals, have been described with reference to FIGS. 4-6, the order of the actions, messages, signals may be modified in other implementations. In addition, non-dependent actions, messages, and signals may represent actions, messages, and signals that can be performed, sent, and/or received in parallel and in different orders. Furthermore, each of the actions, messages, and signals illustrated may include one or more other actions, messages, and/or signals.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code – it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A system comprising:
a device configured to:
receive, from a management device, Network Slice-Area-of-Service (NS-AoS) data per cell and additional data; and
send the NS-AoS data and the additional data to a network function.

2. The system of claim 1, wherein the device includes one of:
a Central Unit (CU); or
a Next Generation Node B (gNB).

3. The system of claim 1, wherein the cell is assigned to the device, and wherein the NS-AoS data includes a cell identifier for the cell and one or more Single-Network Slice Selection Assistance Information (S-NSSAIs) that identify network slices available for the cell.

4. The system of claim 1, wherein the management device comprises:
a Radio Access Network (RAN)-Operation, Administration, and Management (OAM) system.

5. The system of claim 1, wherein the additional data comprises:
a tracking area identifier (TAI) and one or more Single-Network Slice Selection Assistance Information (S-NSSAI).

6. The system of claim 1, wherein the network function comprises:
an Access and Mobility Management function (AMF).

7. The system of claim 6, wherein the AMF is configured to:
receive, from the device, the NS-AoS data via an N2 interface.

8. The system of claim 6, wherein when the AMF receives the NS-AoS data, the AMF is configured to:
receive the NS-AoS data via an NG SETUP REQUEST message, and wherein the AMF is further configured to:
send, in response to the NG SETUP REQUEST message, an NG SETUP RESPONSE message to the device.

9. The system of claim 6, wherein the AMF is configured to:
receive a registration request from a User Equipment device (UE); and
send, in response to the registration request, a registration accept message, which includes a list of allowed network slices, to the UE.

10. The system of claim 9, wherein the AMF is further configured to:
obtain the list of allowed network slices based on network slice identifiers provided in the NS-AoS data and a list of network slices to which the UE is subscribed.

11. A method comprising:
receiving, by a device and from a management device, Network Slice-Area-of-Service (NS-AoS) data per cell and additional data; and
sending the NS-AoS data and the additional data to a network function.

12. The method of claim 11, wherein the device includes one of:
a Central Unit; or
a Next Generation Node B (gNB).

13. The method of claim 11, wherein the cell is assigned to the device, and wherein the NS-AoS data includes a cell identifier for the cell and one or more Single Network Slice Selection Assistance Information (S-NSSAIs) that identify network slices available for the cell.

14. The method of claim 11, wherein the management device comprises:
a Radio Access Network (RAN)-Operation, Administration, and Management (OAM) system.

15. The method of claim 11, wherein the additional data comprises:
a tracking area identifier (TAI) and one or more Single-Network Slice Selection Assistance Information (S-NSSAIs).

16. The method of claim 11, wherein the network function comprises:
an Access and Mobility Management function (AMF).

17. The method of claim 16, further comprising:
receiving, by the AMF and from the device, the NS-AoS data via an N2 interface.

18. The method of claim 16, wherein receiving, by the AMF and from the device, the NS-AoS comprises:
receiving the NS-AoS data via an NG SETUP REQUEST message, and wherein the method further comprises:
sending, in response to the NG SETUP REQUEST message, an NG SETUP RESPONSE message to the device.

19. The method of claim 16, further comprising:
receiving, by the AMF, a registration request from a User Equipment device (UE); and
sending, by the AMF and in response to the registration request, a registration accept message, which includes a list of allowed network slices, to the UE.

20. A non-transitory computer-readable medium comprising processor-executable instructions, which when executed by one or more processors included in a device, cause the one or more processors to:
receive, from a management device, Network Slice-Area-of-Service (NS-AoS) data per cell and additional data; and
send the NS-AoS data and the additional data to a network function.
